(19) United States
(12) Patent Application Publication
(10) Pub. No.: US 2015/0263796 A1
(43) Pub. Date: Sep. 17, 2015

(54) CHANNEL STATE INFORMATION FOR REPORTING AN ADVANCED WIRELESS COMMUNICATIONS SYSTEM

(71) Applicant: Samsung Electronics Co., Ltd., Suwon-si (KR)

(72) Inventors: Young Han Nam, Plano, TX (US); Md. Saifur Rahman, Richardson, TX (US); Boon Loong Ng, Plano, TX (US)

(21) Appl. No.: 14/581,636

(22) Filed: Dec. 23, 2014

Related U.S. Application Data
(60) Provisional application No. 62/036,365, filed on Aug. 12, 2014.
(60) Provisional application No. 61/953,449, filed on Mar. 14, 2014.

(51) Int. Cl. H04B 7/04; H04W 72/04; H04L 1/18; H04B 7/06

(52) U.S. Cl. CPC H04B 7/0417; H04B 7/0632; H04B 7/0452; H04W 72/0413; H04L 1/1812

(57) ABSTRACT

Multi-user channel quality, information (MU-CQI) indicating demodulation interference at the user equipment between co-channel signals within a multi-user, multiple input multiple output (MU-MIMO) transmission is derived utilizing a demodulation interference measurement resource (DM-IMR) and based upon a demodulation reference signal (DMRS). Derivation of signal, interference, and signal-plus-interference parts of the MU-CQI is configurable, as is the MU-CQI reporting, selection of physical resource blocks (PRBs) to be employed, and periods, subframes and/or antenna ports for determining MU-CQI. The interfering transmission may originate from the same transmission point as the desired signal or from a different transmission point.

This application claims priority to and hereby incorporates by reference U.S. Provisional Patent Application No. 61/953,449, filed Mar. 14, 2014, entitled “CHANNEL STATE INFORMATION REPORTING FOR AN ADVANCED WIRELESS COMMUNICATION SYSTEMS” and U.S. Provisional Patent Application No. 62/036,365, filed Aug. 12, 2014, entitled “CHANNEL STATE INFORMATION REPORTING FOR ADVANCED WIRELESS COMMUNICATION SYSTEMS.”

### TECHNICAL FIELD

The present disclosure relates generally to reporting channel state information in a wireless communication system and, more specifically, to accounting for demodulation interference in reporting channel quality.

### BACKGROUND

Existing channel quality reporting processes in wireless communications systems do not sufficiently account for demodulation interference at a user equipment for multi-user, multiple input multiple output transmissions.

There is, therefore, a need in the art for improved channel quality reporting in wireless communications systems.

### SUMMARY

Multi-user channel quality information (MU-CQI) indicating demodulation interference at the user equipment between co-channel signals within a multi-user, multiple input multiple output (MU-MIMO) transmission is derived utilizing a demodulation interference measurement resource (DM-IMR) and based upon a demodulation reference signal (DMRS). Derivation of signal, interference, and signal-plus-interference parts of the MU-CQI is configurable, as is the MU-CQI reporting, selection of physical resource blocks (PRBs) to be employed, and periods, subframes and/or antenna ports for determining MU-CQI. The interfering transmission may originate from the same transmission point as the desired signal or from a different transmission point.

In one embodiment of the present disclosure, a user equipment includes a receiver configured to receive, via a first set of demodulation reference signal (DMRS) antenna ports, a set of physical resource blocks (PRBs) in a single subframe on a physical downlink shared channel (PDSCH) from a transmission point in a wireless communication system, each of the PRBs including a demodulation interference measurement resource (DM-IMR) received via at least one DMRS antenna port other than the first set of DMRS antenna ports. The user equipment also includes a controller configured to demodulate the PDSCH and to estimate a signal part of channel quality information (CQI) from a PRB in the set of PRBs received via the first set of DMRS ports and to determine an interference part of the CQI based upon DM-IMRs within PRBs in the set of PRBs received via the at least one other DMRS antenna port. The user equipment further includes a transmitter configured to transmit, to the transmission point, an indication of the CQI.

In another embodiment of the present disclosure, a base station includes a transmitter configured to transmit, for reception at a user equipment via a first set of demodulation reference signal (DMRS) antenna ports, a set of physical resource blocks (PRBs) in a single subframe on a physical downlink shared channel (PDSCH) in a wireless communication system, each of the PRBs including a demodulation interference measurement resource (DM-IMR) for reception at the user equipment via at least one DMRS antenna port other than the first set of DMRS antenna ports. The base station also includes a receiver configured to receive, from the user equipment, an indication of channel quality information (CQI) determined by the user equipment by estimating a signal part of the CQI from a PRB in the set of PRBs received at the user equipment via the first set of DMRS ports and by determining an interference part of the CQI based upon DM-IMRs within PRBs in the set of PRBs received at the user equipment via the at least one other DMRS antenna port.

In one alternative embodiment of the present disclosure, a method involves receiving, at a receiver in a user equipment via a first set of demodulation reference signal (DMRS) antenna ports, a set of physical resource blocks (PRBs) in a single subframe on a physical downlink shared channel (PDSCH) from a transmission point in a wireless communication system, each of the PRBs including a demodulation interference measurement resource (DM-IMR) received via at least one DMRS antenna port other than the first set of DMRS antenna ports. The method also involves employing a controller within the user equipment to demodulate the PDSCH, to estimate a signal part of channel quality information (CQI) from a PRB in the set of PRBs received via the first set of DMRS ports, and to determine an interference part of the CQI based upon DM-IMRs within PRBs in the set of PRBs received via the at least one other DMRS antenna port. The method further involves transmit, from a transmitter in the user equipment to the transmission point, an indication of the CQI.

In a second alternative embodiment of the present disclosure, a method involves transmitting, from a transmitter at a base station includes for reception at a user equipment via a first set of demodulation reference signal (DMRS) antenna ports, a set of physical resource blocks (PRBs) in a single subframe on a physical downlink shared channel (PDSCH) in a wireless communication system, each of the PRBs including a demodulation interference measurement resource (DM-IMR) for reception at the user equipment via at least one DMRS antenna port other than the first set of DMRS antenna ports. The method also involves receiving, at a receiver within the base station the user equipment, an indication of channel quality information (CQI) determined by the user equipment by estimating a signal part of the CQI from a PRB in the set of PRBs received at the user equipment via the first set of DMRS ports and by determining an interference part of the CQI based upon DM-IMRs within PRBs in the set of PRBs received at the user equipment via the at least one other DMRS antenna port.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, where such a device, system or part may be implemented in hardware that is programmable by firmware or software. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates SU-MIMO and MU-MIMO operation according to 3GPP LTE standards;

FIGS. 2A through 2F illustrate the resource elements used for UE-specific reference signals for normal cyclic prefix for selected antenna ports in accordance with one embodiment of the present disclosure;

FIGS. 3A and 3B illustrate the resource elements used for UE-specific reference signals for extended cyclic prefix for selected antenna ports in accordance with one embodiment of the present disclosure;

FIG. 4 illustrates timing of wideband PMI/CQI and subband PMI/CQI in accordance with some embodiments of the present disclosure;

FIG. 5 is a high level flow diagram for a process involved in the proposed DM-IMR based DMRS CQI computation and reporting in accordance with some embodiments of the present disclosure;

FIG. 6 illustrates an exemplary RE mapping of a PRB used for estimating signal and interference part of the CQI, wherein the UE utilize the configured NZP CSI-RS to estimate CSI-RS and DM-IMR to estimate interference for the CQI, in accordance with some embodiments of the present disclosure;

FIGS. 7A and 7B illustrate exemplary PUCCH reporting with different locations for the CSI reference resource in accordance with some embodiments of the present disclosure;

FIG. 8 illustrates a CSI measurement period defined by UE implementation in accordance with some embodiments of the present disclosure;

FIG. 9 illustrates a CSI reference resource period in accordance with some embodiments of the present disclosure;

FIG. 10 illustrates CSI reference resources and periodic CSI reporting in accordance with some embodiments of the present disclosure;

FIG. 11 illustrates an example of a periodic cell-specific DM-IMR in accordance with some embodiments of the present disclosure;

FIG. 12 illustrates a PRB used for estimating signal and interference parts of the CQI in accordance with some embodiments of the present disclosure;

FIG. 13 illustrates estimation of the signal and the interference parts of the CQI in the same subframe n based on the configuration in accordance with some embodiments of the present disclosure;

FIG. 14 illustrates estimation of the signal and interference parts of the CQI in two different subframes in accordance with some embodiments of the present disclosure;

FIG. 15 illustrates estimation by a UE of interference coming from multiple transmission points using different use DMRS ports for interference estimation and PDSCH demodulation in accordance with some embodiments of the present disclosure; and

FIG. 16 is a plot illustrating comparative performance of different CQI reporting.

### DETAILED DESCRIPTION

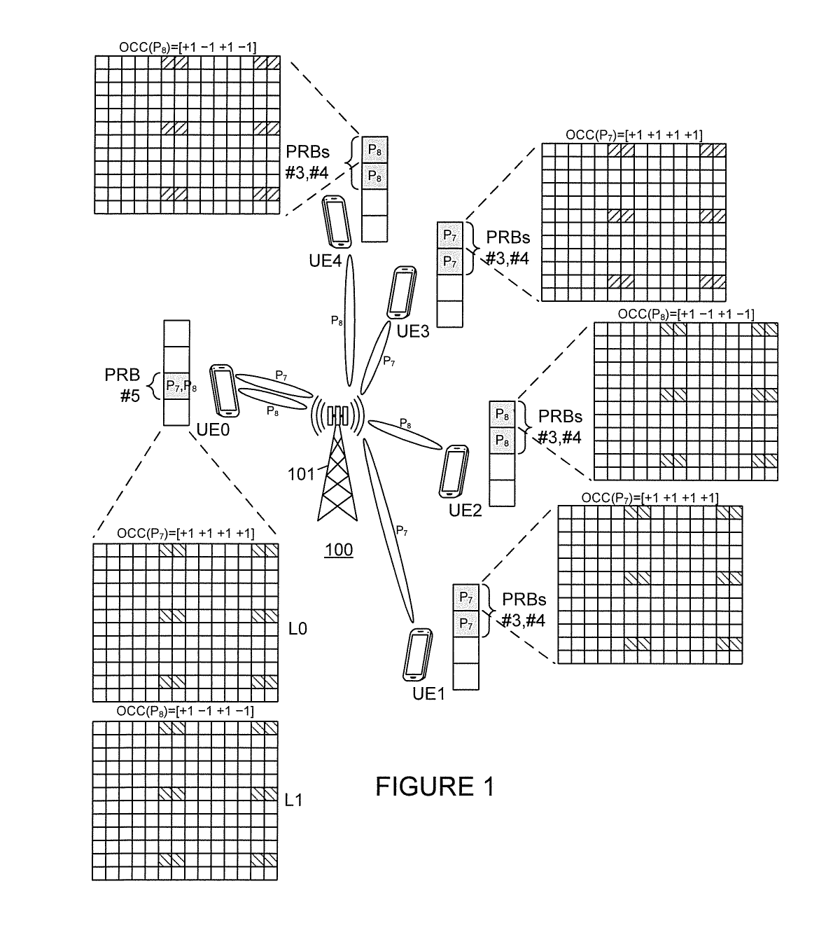

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents are hereby incorporated herein by reference: [REF1]: 3GPP TS36.211; [REF2]: 3GPP TS36.212; and [REF3]: 3GPP TS36.213.

### LIST OF ACRONYMS

MIMO: multiple-input-multiple-output
SU-MIMO: single-user MIMO
MU-MIMO: multi-user MIMO
3GPP: 3rd Generation Partnership Project
LTE: long-term evolution
UE: user equipment
eNB: eNodeB
(P)RB: (physical) resource block
OCC: orthogonal cover code
DMRS: demodulation reference signal(s)
UE-RS: UE-specific reference signal(s)
CSI-RS: channel state information reference signals
SCID: scrambling identity
MCS: modulation and coding scheme
RE: resource element
CQI: channel quality information
PMI: precoding matrix indicator
RI: rank indicator
MU-CQI: multi-user CQI
CSI: channel state information
CSI-IM: CSI interference measurement
CoMP: coordinated multi-point
NZP: non-zero power
DCI: downlink control information
DL: downlink
UL: uplink
PDSCH: physical downlink shared channel
PDCCH: physical downlink control channel
PUSCH: physical uplink shared channel
PUCCH: physical uplink control channel
CDM: code-division multiplexing
RRC: radio resource control
DM-IMR: demodulation interference measurement resource
FD-MIMO: full-dimension MIMO

Multi-user MIMO corresponds to a transmission scheme in which a transmitter can transmit data to two or more UEs using the same time/frequency resource by relying on spatial separation of the corresponding UE's channels.

FIG. 1 illustrates SU-MIMO and MU-MIMO operation according to 3GPP LTE standards. The UEs each include an antenna array, a receiver coupled to the antenna array for demodulating received wireless signals, a controller deriving channel quality information, and a transmitter for transmitting feedback to a base station. Each base station likewise includes at least an antenna array for transmitting and receiving signals, a receiver chain, a controller, and a transmitter chain. On PRB 5, UE0 receives two streams on antenna ports 7 and 8 from eNB 100, for which the UE-RSs are orthogonally multiplexed on a set of resource elements (REs). On PRBs 3 and 4, eNB 100 multiplexes two data streams intended for UE1 and UE3 on antenna port 7 and two data streams intended for UE2 and UE4 on antenna port 8, where scrambling initialization with n_{SCID}=0 is applied for UE1 and UE2 while scrambling initialization with n_{SCID}=1 is applied for UE3 and UE4. eNB 100 may further apply four different precoding vectors respectively for precoding PDSCHs and DMRSs of the four streams. The DMRSs transmitted on antenna ports 7 and 8 with the same SCID are orthogonally multiplexed by respectively applying two orthogonal cover codes (OCCs): [+1 +1 +1 +1] and [+1 −1 +1 −1], wherein the orthogonal cover codes are applied across the four DMRS REs on the same subcarrier. It is noted that in 3GPP LTE specifications, DMRS is sometimes called UE-specific reference signals (UE-RS).

Transmission points (TPs) are network nodes that can transmit downlink signals and receive uplink signals in a cellular network, examples of which include base stations, NodeCs, eNBs 100, remote radio heads (RRHs), etc.

In the legacy specifications of LTE, UEs feedback a CQI in addition to the PMI and RI, where the CQI corresponds to a supported Modulation and Coding Scheme (MCS) level that can be supported reliably by the UE, within a certain target error probability. The feedback designs in the legacy specifications of LTE are optimized for single user MIMO.

With MU-MIMO, however, the MCS to be used by the scheduler for each user needs to be determined at the eNB. The MCS that can be supported reliably for each UE is dependent on co-channel PMI corresponding to the co-scheduled UE. On the other hand, for scheduling flexibility the transmitter may pair a user with any other UE. So, methods must be defined to compute multi-user CQI (MU-CQI) at the UE such that the reported MU-CQI allows better prediction at the eNB. Relying completely on eNB predictions of MCS may not be accurate since the receiver implementation specific algorithms like interference cancellation/suppression also need to be accurately reflected in any MU-CQI calculation.

This disclosure proposes that a UE can be configured to derive CQI with interference measured with demodulation interference measurement resource (DM-IMR) and report back the derived CQI to the transmission point (TP). A DM-IMR comprises a set of DMRS REs on a set of PRBs in a set of subframes, where the UE utilizes UE-RS sequence(s) to estimate interfering channels on the DM-IMR.

DM-IMR is DMRS other than those DMRS scrambled according to specified scrambling initialization parameter(s) carried on a set of antenna ports indicated in a DCI carried on PDCCH in subframe n, wherein the DCI schedules a PDSCH for the UE within a set of PRBs in subframe n. In this case, the DM-IMR can be further confined within the set of PRBs in subframe n on which the PDSCH is transmitted.

The UE further receives DCI format 2C or 2D which includes antenna port(s), scrambling identity and number of layers indication, wherein the indication configures a set of antenna ports and n_{SCID}. The UE is then further configured to use the DMRS generated with n_{SCID} on the set of antenna ports for deriving the signal part of the CQI, and to use DM-IMR determined according to MU-MIMO dimensioning configuration for deriving the interference part of the CQI.

MU-MIMO dimensioning is determined based upon configured transmission mode. For example, when a UE is configured with TM 8, 9 and 10, MU-MIMO dimensioning is such that 4 DMRS on (antenna port, n_{SCID})={(7, 0), (7, 1), (8, 0), (8, 1)} can simultaneously be used for MU-MIMO transmission; when a UE is configured with a new TM, MU-MIMO dimensioning can be configured by higher-layer.

MU-MIMO dimensioning is determined based upon a state of an information element conveyed in the higher layer (e.g., RRC). In one example, the information element comprises a 4-bit bitmap signaling for including/excluding each of (antenna port, n_{SCID})=(7, 0), (7, 1), (8, 0) and (8, 1) in the set determining the MU-MIMO dimensioning.

DM-IMR is explicitly configured by higher-layer (e.g., RRC), wherein the higher-layer configuration may include information at least one of a set of antenna ports, a set of pairs of antenna port and n_{SCID}, a set of subframes to contain DM-IMR (in terms of subframe period and subframe offset), a set of PRBs to contain DM-IMR (a bitmap to indicate inclusion/exclusion of each PRB within the set), etc.

Information regarding PRBs containing DM-IMR is configured for the UE. This PRB configuration can be done in UE-specific or cell-specific manner.

When the UE decodes a DCI on PDCCH scheduling a PDSCH on a set of PRBs (e.g., DCI format 1A/2/2A/2B/2C/2D) in subframe n, the UE determines the PRBs containing DM-IMR of subframe n being the same as the set of PRBs, wherein the set of PRBs can be indicated in the resource assignment field in the DCI.

Information regarding a set of subframes containing DM-IMR is configured for the UE. This configuration can be done in UE-specific or cell-specific manner. A few alternative methods are devised for configuring information regarding the set of subframes for DM-IMR for the UE, when the UE needs to feed back CQI in subframe n:
i. The set of subframes is a single subframe n−k on which a PDSCH intended for the UE is transmitted, wherein the UE is also requested to transmit aperiodic CSI on PUSCH in subframe n.
ii. The set of subframes is measurement subframes between two PUCCH reporting instances.
iii. The set of subframes is measurement subframes before a PUCCH reporting instance (subframe n).
iv. The set of subframes is measurement subframes before the PUSCH reporting instance (subframe n), when the UE is requested to transmit aperiodic CSI on PUSCH in subframe n.
v. The set of subframes is measurement subframes before the PUSCH reporting instance (subframe n) but no earlier than subframe n−K, when the UE is requested to transmit aperiodic CSI on PUSCH in subframe n, wherein K is configured by a higher-layer, or pre-configured.

The UE is further configured to estimate the signal part of the CQI with non-zero-power (NZP) CSI-RS.

The present disclosure differs from other proposals by devising improved signaling methods for the UE to determine interfering DMRS ports and signal DMRS ports, for example, when the UE receives a PDSCH assignment together with DMRS port allocation and a UL grant same time in subframe n, wherein the UL grant includes a one-bit codepoint to indicate whether or the UE to report DMRS-CQI. If the UE is indicated to report DMRS-CQI, the UE utilizes the allocated DMRS to estimate the signal part of the CQI, and the other DMRS than the allocated DMRS to estimate the interference part of the CQI. In addition, the present invention also proposes detailed UE operation to derive interfering DMRS ports in time and frequency domain.

The above-described mechanism does not incur much overhead to realize MU-CQI in the wireless communication system, because the eNB may schedule MU-MIMO PDSCH for multiple UEs as in the conventional system, and the eNB requests the multiple UEs to estimate the “real” MU-MIMO interference in the interfering DMRS ports by means of small-overhead signaling. The additional overhead here can be only the signaling overhead, which can be as little as one bit dynamic signaling, and on the order of 10 bits in semi-static signaling. The method does not necessarily incur additional reference signal overhead.

CSI Processes and CSI-IM

For a UE in transmission mode 10 (also known as the CoMP (coordinated multi-point) transmission mode in 3GPP LTE), the UE shall derive the interference measurements for computing the CQI value reported in uplink subframe n and corresponding to a CSI process, based on only the zero power CSI-RS within the configured channel state information interference measurement (CSI-IM) resource associated with the CSI process. If the UE in transmission mode 10 is configured by higher layers for CSI subframe sets C_{CSI,0} and C_{CSI,1} for the CSI process, the configured CSI-IM resource within the subframe subset belonging to the CSI reference resource is used to derive the interference measurement.

By configuring a UE with multiple CSI processes, eNB can utilize multiple CSI derived with various interference conditions for the scheduling of the UE, with implementing CoMP dynamic point selection (DPS) and dynamic point blanking (DPB).

CSI-IM has been introduced for 3GPP LTE Rel-11 CoMP. For a serving cell and UE configured in transmission mode 10, the UE can be configured with one or more CSI-IM resource configuration(s). The following parameters are configured via higher layer signaling for each CSI-IM resource configuration:
Zero-power CSI RS Configuration, and
Zero-power CSI RS subframe configuration I_{CSI-RS}.

A UE in transmission mode 10 can be configured with one or more CSI processes per serving cell by higher layers. Each CSI process is associated with a non-zero power (NZP) CSI-RS resource and a CSI-interference measurement (CSI-IM) resource. A CSI reported by the UE corresponds to a CSI process configured by higher layers. Each CSI process can be configured with or without PMI/RI reporting by higher layer signaling.

CQI Derivation with Separate Measurement of Signal and Interference Parts

In 3GPP LTE Rel-11 specifications (3GPP TS36.213), the following example method is described to derive CQI based upon separate measurement of signal and interference parts:

For a UE in transmission mode 10, the UE shall derive the channel (or signal part) measurements for computing the CQI value reported in uplink subframe n and corresponding to a CSI process, based on only the non-zero power CSI-RS (defined in [REF3]) within a configured CSI-RS resource associated with the CSI process.

For a UE in transmission mode 10, the UE shall derive the interference (or interference part) measurements for computing the CQI value reported in uplink subframe n and corresponding to a CSI process, based on only the zero power CSI-RS (defined in [REF3]) within the configured CSI-IM resource associated with the CSI process. If the UE in transmission mode 10 is configured by higher layers for CSI subframe sets C_{CSI, 0} and C_{CSI,1} for the CSI process, the configured CSI-IM resource within the subframe subset belonging to the CSI reference resource is used to derive the interference measurement.

### Antenna Port Indication, Sequence, and Resource Element Mapping of DMRS

According to the legacy LTE specifications (3GPP TS36.212), a UE is dynamically indicated in a DL assignment (e.g., DCI format 2B, 2C, 2D) with a set of antenna ports to estimate channels for demodulating the scheduled PDSCH. In case of DCI format 2C and 2D, a 3-bit information field, Antenna port(s), scrambling identity and number of layers, is defined according to TABLE 1:

TABLE 1
Antenna port(s), scrambling identity
and number of layers indication

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, n_{SCID} = 0 |
| 1 | 1 layer, port 7, n_{SCID} = 1 | 1 | 2 layers, port 7-8, n_{SCID} = 1 |
| 2 | 1 layer, port 8, n_{SCID} = 0 | 2 | 3 layers, ports 7-9 |
| 3 | 1 layer, port 8, n_{SCID} = 0 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-14 |

For example, when a UE is indicated with the value 1 and codeword 0 enabled while codeword 1 is disabled in DCI format 2C or 2D, the UE shall estimate channels utilizing antenna port 7 for demodulation of the signal layer carrying its PDSCH with applying scrambling initialization utilizing n_{SCID}=1.

Let v be number of layers, N_{RB}^{max,DL} be maximum number of RBs in downlink, N_{DI}^{cell} be physical cell identifier (ID) of the serving cell, and n_{PRB} be a PRB number. For any of the antenna ports pε7, 8, . . . , v+6), the reference-signal sequence r(m) is defined by

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix}$$

The pseudo-random sequence c(i) is defined in Section 7.2 of 3GPP TS36.211. The pseudo-random sequence generator shall be initialized with

cᵢₙᵢₜ=└nₛ/2┘+1)·(2n_{ID}⁽ⁿ^{_{SCID}}⁾+1)·2¹⁶+n_{SCID}

at the start of each subframe.

The quantities n_{ID}⁽ⁱ⁾, i=0, 1, are given by
n_{ID}⁽ⁱ⁾=N_{ID}^{cell} if no value for n_{ID}^{DMRS,i} is provided by higher layers or if DCI format 1A, 2B or 2C is used for the DCI associated with the PDSCH transmission; and
n_{ID}⁽ⁱ⁾=n_{ID}^{DMRS,i} otherwise.

The value of n_{SCID} is zero unless specified otherwise. For a PDSCH transmission on ports 7 or 8, n_{SCID} is given by the DCI format 2B, 2C or 2D (i.e., TABLE 1) associated with the PDSCH transmission.

For antenna ports p=7, p=8 or p=7, 8, . . . , v+6, in a physical resource block with frequency-domain index n_{PRB} assigned for the corresponding PDSCH transmission, a part of the reference signal sequence r(m) shall be mapped to complex-valued modulation symbols a_{k,l}^{(p)} in a subframe according to:

Normal Cyclic Prefix:

a_{k,l}^{(p)}=wₚ(l′)·r(3·l′·N_{RB}^{max,DL}+3·n_{PRB}·m′)

where (see Table 4.2-1 for special subframe configurations referenced for l and l′):

$${w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} \\ k = 5 {m}^{′} + {N}_{sc}^{RB} {n}_{PRB} + {k}^{′} \\ {k}^{′} = \{ \begin{matrix}1 & p ∈ \{ 7 , 8 , 11 , 13 \} \\ 0 & p ∈ \{ 9 , 10 , 12 , 14 \}\end{matrix} \\ l = \{ \begin{matrix}{l}^{′} mod 2 + 2 & & in special subframe config . 3 , 4 , 8 or 9 \\ {l}^{′} mod 2 + 3 & ⌊ {l}^{′} / 2 ⌋ & in special subframe config . 1 , 2 , 6 or 7 \\ {l}^{′} mod 2 + 5 & & if not in a special subframe\end{matrix} \\ {l}^{′} = \{ \begin{matrix}0 , 1 , 2 , 3 & \begin{matrix}if {n}_{s} mod 2 = 0 and \\ in special subframe config . 1 , 2 , 6 or 7\end{matrix} \\ 0 , 1 & \begin{matrix}if {n}_{s} mod 2 = 0 and \\ in special subframe config . 1 , 2 , 6 or 7\end{matrix} \\ 2 , 3 & \begin{matrix}if {n}_{s} mod 2 = 1 and \\ not in special subframe config . 1 , 2 , 6 or 7\end{matrix} \end{matrix} \\ {m}^{′} = 0 , 1 , 2 ,$$

The sequence w̅ₚ (i) is given by TABLE 2:

TABLE 2
The sequence w̅ₚ (i) for normal cyclic prefix

| Antenna port p | [ w̅ₚ (0) w̅ₚ (1) w̅ₚ (2) w̅ₚ (3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

Extended Cyclic Prefix:

a_{k,l}^{(p)}=wₚ(l′ mod 2)·r(4·l′·N_{RB}^{max,DL}+4·n_{PRB}·m′)

where (see Table 4.2-1 for special subframe configurations referenced for l′):

$${w}_{p} ( i ) = \{ \begin{matrix}{\overline{w}}_{p} ( i ) & {m}^{′} mod 2 = 0 \\ {\overline{w}}_{p} ( 1 - i ) & {m}^{′} mod 2 = 1\end{matrix} \\ k = 3 {m}^{′} + {N}_{sc}^{RB} {n}_{PRB} + {k}^{′} \\ {k}^{′} = \{ \begin{matrix}1 & if {n}_{s} mod 2 = 0 and p ∈ \{ 7 , 8 \} \\ 2 & if {n}_{s} mod 2 = 1 and p ∈ \{ 7 , 8 \}\end{matrix} \\ l = {l}^{′} mod 2 + 4 \\ \begin{matrix}{l}^{′} = \{ \begin{matrix}0 , 1 & \begin{matrix}if {n}_{s} mod 2 = 0 and \\ in special subframe config . 1 , 2 , 3 , 5 or 6\end{matrix} \\ 0 , 1 & if {n}_{s} mod 2 = 0 and not in a special subframe \\ 2 , 3 & if {n}_{s} mod 2 = 1 and not in a special subframe\end{matrix} \\ {m}^{′} = 0 , 1 , 2 , 3\end{matrix}$$

The sequence w̅ₚ (i) is given by TABLE 3:

TABLE 3
The sequence w̅ₚ (i) for extended cyclic prefix

| Antenna port p | [ w̅ₚ (0) w̅ₚ (1) w̅ₚ (2) w̅ₚ (3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

For extended cyclic prefix, UE-specific reference signals are not supported on antenna ports 9 to 14.

Resource elements (k, l) used for transmission of UE-specific reference signals to one UE on any of the antenna ports in the set S, where S={7,8,11,13} or S={9,10,12,14} shall
not be used for transmission of PDSCH on any antenna port in the same slot, and
not be used for UE-specific reference signals to the same UE on any antenna port other than those in S in the same slot.

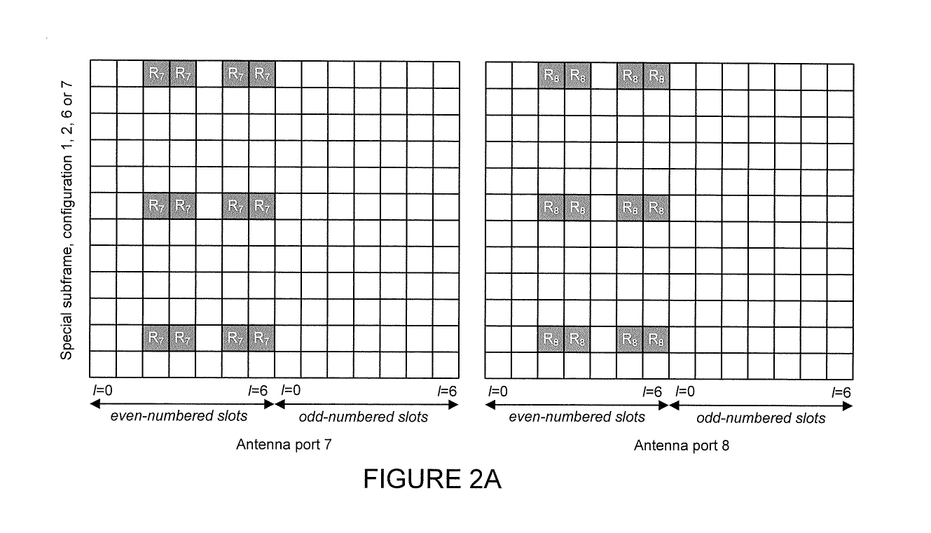

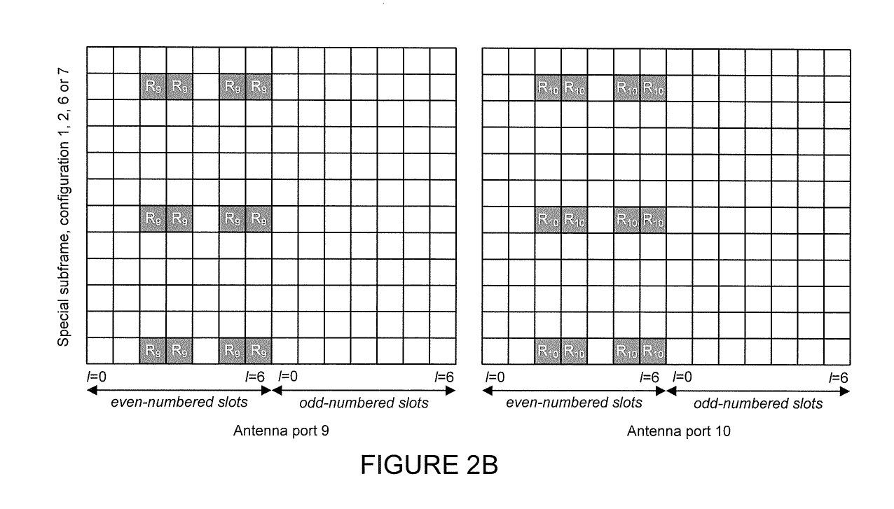

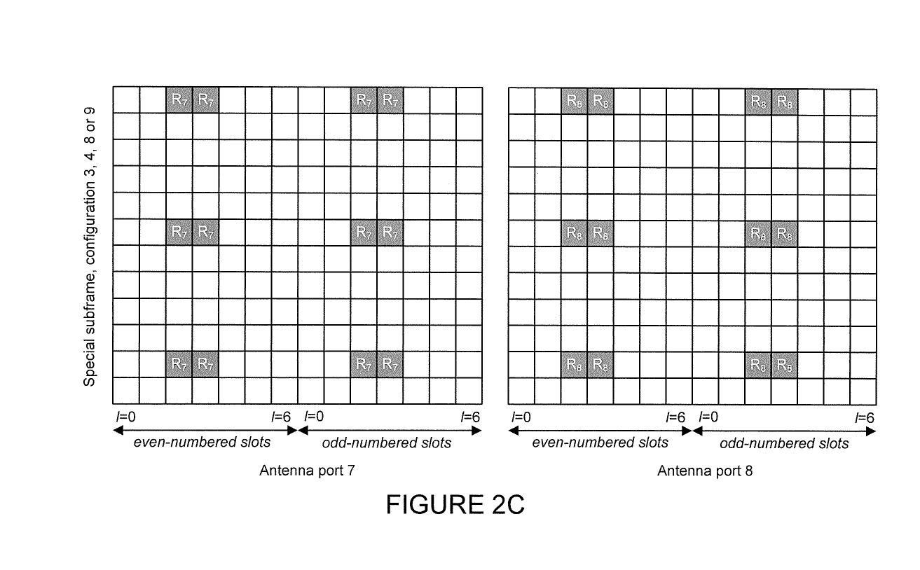

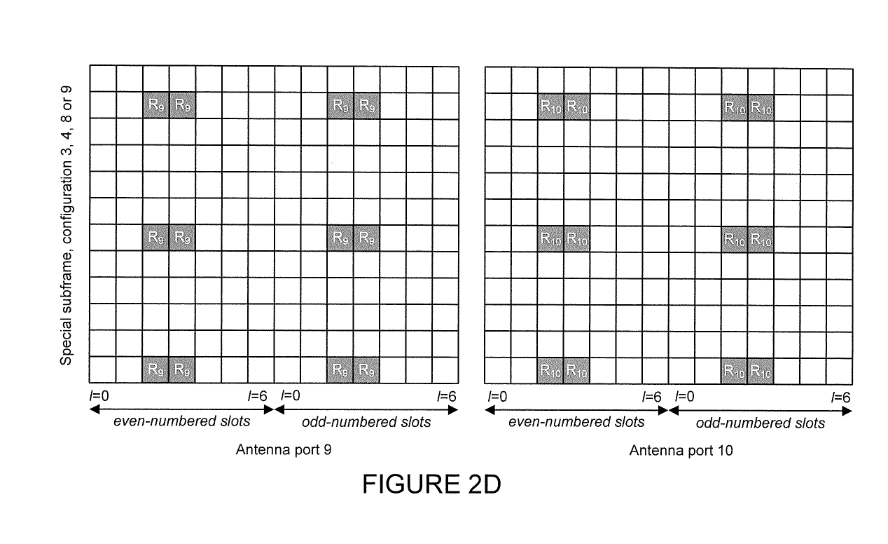

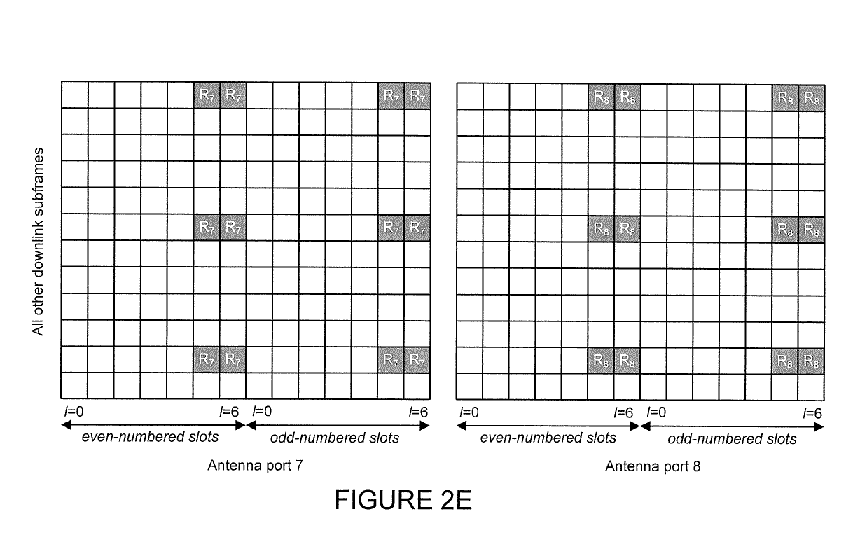

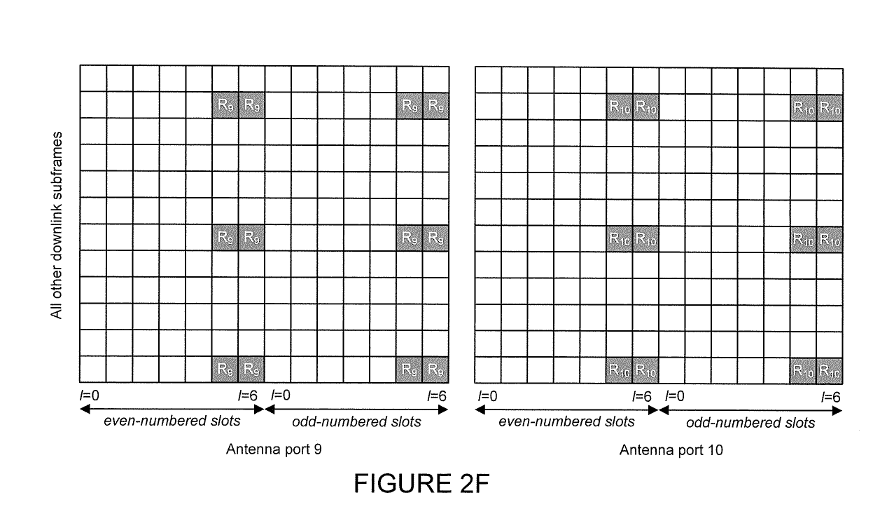

FIGS. 2A through 2F illustrate the resource elements used for UE-specific reference signals for normal cyclic prefix for antenna ports 7, 8, 9 and 10 in accordance with one embodiment of the present disclosure. For a special subframe with configuration 1, 2, 6 or 7: the RE mapping for UE-specific reference signal transmission using antenna port 7 includes RE pairs in the first, sixth and eleventh rows at the columns corresponding to l=2, 3 and l=5, 6 of the even-numbered slots (marked with “R₇” in the mappings in FIG. 2A); the RE mapping for UE-specific reference signal transmission using antenna port 8 also includes RE pairs in the first, sixth and eleventh rows at the columns corresponding to l=2, 3 and l=5, 6 of the even-numbered slots (marked “R₈”); and the RE mappings for UE-specific reference signal transmission using either antenna port 9 or 10 includes RE pairs in the second, seventh and twelfth rows at the columns corresponding to l=2, 3 and l=5, 6 of the even-numbered slots (marked “R₉” and “R₁₀,” respectively, in FIG. 2B). For a special subframe with configuration 3, 4, 8 or 9: the RE mapping for UE-specific reference signal transmission using either antenna port 7 or 8 includes RE pairs in the first, sixth and eleventh rows at the columns corresponding to l=2, 3 of both the even-numbered slots and the odd-numbered slots (marked with “R₇” and “R₈,” respectively, in the mappings in FIG. 2C); and the RE mappings for UE-specific reference signal transmission using either antenna port 9 or 10 includes RE pairs in the second, seventh and twelfth rows at the columns corresponding to l=2, 3 of both the even-numbered slots and the odd-numbered slots (marked “R₉” and “R₁₀,” respectively, in FIG. 2D). For all other downlink subframes: the RE mapping for UE-specific reference signal transmission using either antenna port 7 or 8 includes RE pairs in the first, sixth and eleventh rows at the columns corresponding to l=5, 6 of both the even-numbered slots and the odd-numbered slots (marked with “R₇” and “R₈,” respectively, in the mappings in FIG. 2E); and the RE mappings for UE-specific reference signal transmission using either antenna port 9 or 10 includes RE pairs in the second, seventh and twelfth rows at the columns corresponding to l=5, 6 of both the even-numbered slots and the odd-numbered slots (marked “R₉” and “R₁₀,” respectively, in FIG. 2F).

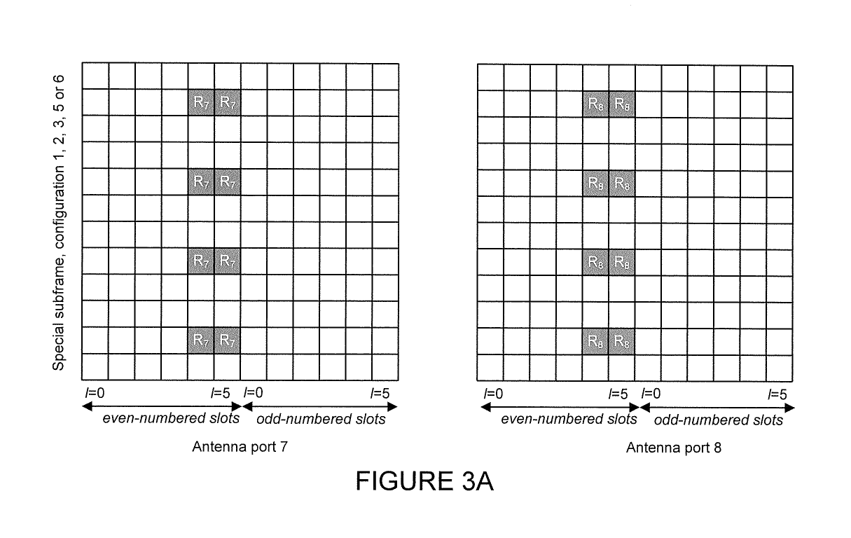

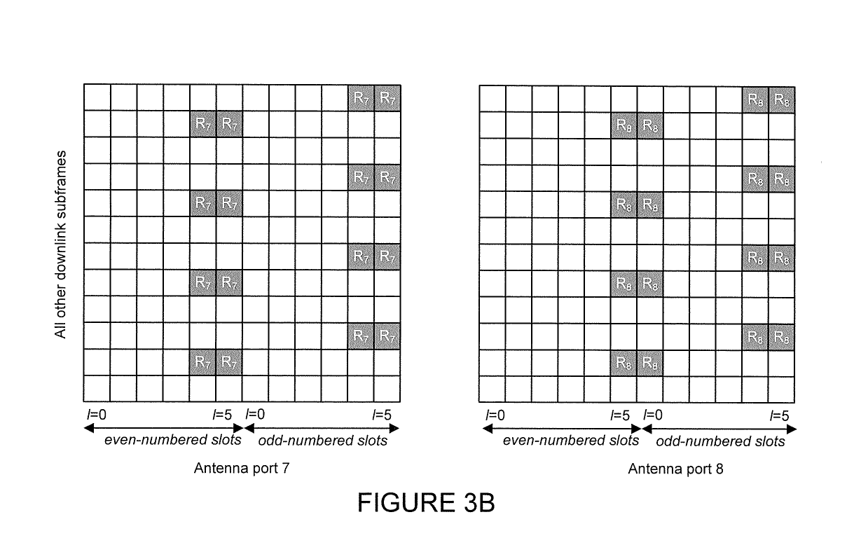

FIGS. 3A and 3B illustrate the resource elements used for UE-specific reference signals for extended cyclic prefix for antenna ports 7 and 8 in accordance with one embodiment of the present disclosure. For a special subframe with configuration 1, 2, 3 5, or 6: the RE mapping for UE-specific reference signal transmission using either antenna port 7 or 8 includes RE pairs in the second, fifth, eighth and eleventh rows at the columns corresponding to l=4, 5 of the even-numbered slots (marked with “R₇” and “R₈,” respectively, in the mappings in FIG. 3A). For all other downlink subframes: the RE mapping for UE-specific reference signal transmission using either antenna port 7 or 8 includes RE pairs in the second, fifth, eighth and eleventh rows at the columns corresponding to l=4, 5 of the even-numbered slots (marked with “R₇” in the mappings in FIG. 3B) and in the first, fourth, seventh and tenth rows at the columns corresponding to l=4, 5 of the odd-numbered slots (marked with “R₈” in the mappings in FIG. 3B).

In the present disclosure, it is proposed that a UE can be configured to derive CQI with interference measured with demodulation interference measurement resource (DM-IMR) and report back the derived CQI to the transmission point (TP). The CQI measured utilizing DM-IMR is denoted as DMRS-CQI. A DM-IMR comprises a set of DMRS REs on a set of PRBs in a set of subframes, wherein the UE utilizes UE-RS sequence(s) to estimate interfering channels on the DM-IMR.

In some embodiments, DM-IMR is the DMRS other than the DMRS scrambled according to specified scrambling initialization parameter(s) carried on a set of antenna ports indicated in a DCI carried on PDCCH in subframe n, wherein the DCI schedules a PDSCH for the UE within a set of PRBs in subframe n. In this case, the DM-IMR can be further confined within the set of PRBs in subframe n on which the PDSCH is transmitted. In these embodiments, it is necessary for a UE to identify MU-MIMO dimensioning first in order to determine DM-IMR, wherein MU-MIMO dimensioning is defined as a set of antenna ports and/or scrambling parameter(s) (e.g., SCID) that a serving cell can simultaneously use/support/transmit for MU-MIMO.

The state of MU-MIMO dimensioning can be explicitly configured by higher-layer, or implicitly configured by other information element/field configured by higher-layer, or can be constant which does not vary over time.

In one method, MU-MIMO dimensioning is determined based upon configured transmission mode. For example, when a UE is configured with TM 8, 9 and 10, MU-MIMO dimensioning is such that 4 DMRS on (antenna port, n_{SCID})={(7, 0), (7, 1), (8, 0), (8, 1)} can simultaneously be used for MU-MIMO transmission; when a UE is configured with a new TM, MU-MIMO dimensioning can be configured by higher-layer.

In another method, MU-MIMO dimensioning is determined based upon a state of an information element conveyed in the higher layer (e.g., RRC).

In one example, the information element comprises a 4-bit bitmap signaling for including/excluding each of (antenna port, n_{SCID})=(7, 0), (7, 1), (8, 0) and (8, 1) in the set determining the MU-MIMO dimensioning.

In another example, the information element comprises a 8-bit bitmap signaling for including/excluding each of (antenna port)=7, 8, 9, 10, 11, 12, 13 and 14 in the set determining the MU-MIMO dimensioning, wherein n_{SCID} is constant (e.g., =0) and is not explicitly signaled.

In some embodiments, DM-IMR is explicitly configured by higher-layer (e.g., RRC), wherein the higher-layer configuration may include information at least one of a set of antenna ports, a set of pairs of antenna port and n_{SCID} a set of subframes to contain DM-IMR (in terms of subframe period and subframe offset), a set of PRBs to contain DM-IMR (a bitmap to indicate inclusion/exclusion of each PRB within the set), etc.

The set of antenna ports can be determined based upon a state of an information element conveyed in the higher layer (e.g., RRC). In one example, the information element comprises a 8-bit bitmap signaling for including/excluding each of (antenna port)=7, 8, 9, 10, 11, 12, 13 and 14 in the set determining the MU-MIMO dimensioning, wherein n_{SCID} is constant (e.g., =0) and is not explicitly signaled.

The set of pairs of an antenna port and n_{SCID} can be determined based upon a state of an information element conveyed in the higher layer (e.g., RRC). In one example, the information element comprises a 4-bit bitmap signaling for including/excluding each of (antenna port, n_{SCID})=(7, 0), (7, 1), (8, 0) and (8, 1) in the set determining the MU-MIMO dimensioning.

In some embodiments, DMRS for PDSCH demodulation and DMRS for DM-IMR may be configured in two different subframes n and m, respectively. In this case, the set of PRBs in subframe n for PDSCH demodulation and the set of PRBs in subframe m for DM-IMR may be the same. Furthermore, the DMRS ports for PDSCH demodulation and DM-IMR may or may not be the same.

In some embodiments, information regarding PRBs containing DM-IMR is configured for the UE. This configuration may be necessary because DMRS is in nature to be provided to PRBs corresponding to PDSCH allocation and it does not necessarily need to be transmitted in the full bandwidth. This PRB configuration can be done in UE-specific or cell-specific manner. A few alternative methods are devised for configuring information regarding the PRBs for DM-IMR for the UE.
The DM-IMR spans the full DL system bandwidth (NE PRBs).
When the UE decodes a DCI on PDCCH scheduling a PDSCH on a set of PRBs (e.g., DCI format 1A/2/2A/2B/2C/2D) in subframe n, the UE determines the PRBs containing DM-IMR of subframe n being the same as the set of PRBs, wherein the set of PRBs can be indicated in the resource assignment field in the DCI.
For deriving a subband CQI of subband k, the UE shall use DM-IMR in the PRBs comprising the corresponding subband (i.e., subband k) for estimating interference part for the subband CQI
The UE is configured with information indicating the PRBs containing DM-IMR by higher layer (such as RRC).

In some embodiments, information regarding a set of subframes containing DM-IMR is configured for the UE. This configuration can be done in UE-specific or cell-specific manner. A few alternative methods are devised for configuring information regarding the set of subframes for DM-IMR for the UE, when the UE needs to feed back CQI in subframe n.
The set of subframes is a single subframe n−k on which a PDSCH intended for the UE is transmitted, wherein the UE is also requested to transmit aperiodic CSI on PUSCH in subframe n.
The set of subframes is measurement subframes between two PUCCH reporting instances.
The set of subframes is measurement subframes before a PUCCH reporting instance (subframe n).
The set of subframes is measurement subframes before the PUSCH reporting instance (subframe n), when the UE is requested to transmit aperiodic CSI on PUSCH in subframe n.
The set of subframes is measurement subframes before the PUSCH reporting instance (subframe n) but no earlier than subframe n−K, when the UE is requested to transmit aperiodic CSI on PUSCH in subframe n, wherein K is configured by higher-layer, or pre-configured.

In these methods, measurement subframes are alternatively defined as:
A set of subframes in which the UE is assigned a PDSCH whose demodulation reference is DMRS, i.e., the PDSCH is scheduled by DCI format 2B/2C/2D or similar DCI format capable of scheduling a PDSCH whose demodulation reference is DMRS.
A set of subframes configured by higher-layer.

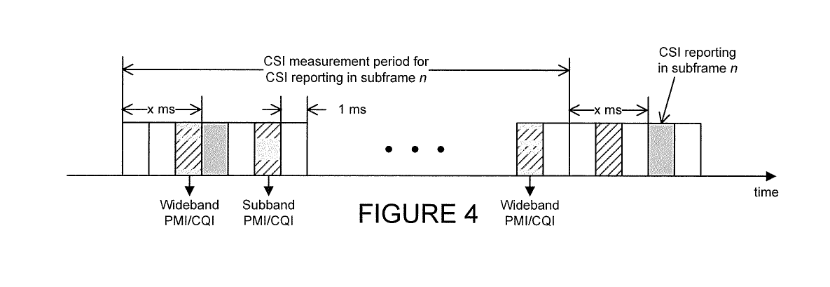

In some embodiments, the DM-IMR is determined according to the downlink assignment resource allocation in a downlink subframe. In this case, “wideband” or “subband” PMI/CQI can be characterized according to the resource allocation for a downlink subframe. If a resource allocation detected for a downlink subframe is distributed (e.g. Resource Allocation Type 2 as described in 3GPP TS 36.213), the PMI/CQI measured can be characterized as “wideband”; otherwise if the resource allocation detected for a downlink subframe is localized (e.g. Resource Allocation Type 0 as described in 3GPP TS 36.213), the PMI/CQI measured can be characterized as “subband.” The “subband” PMI/CQI can also be averaged across multiple measurement subframes to generate a “wideband” PMI/CQI which is approximately true if resource allocations for the subframes concerned cover various part of the system bandwidth. This concept is illustrated in FIG. 4. CSI reporting for subframe n occurs x milliseconds (ms) after the CSI measurement period for CSI reporting in subframe n. Wideband PMI/CQI and subband PMI/CQI occurs in selected periods other than those reporting periods.

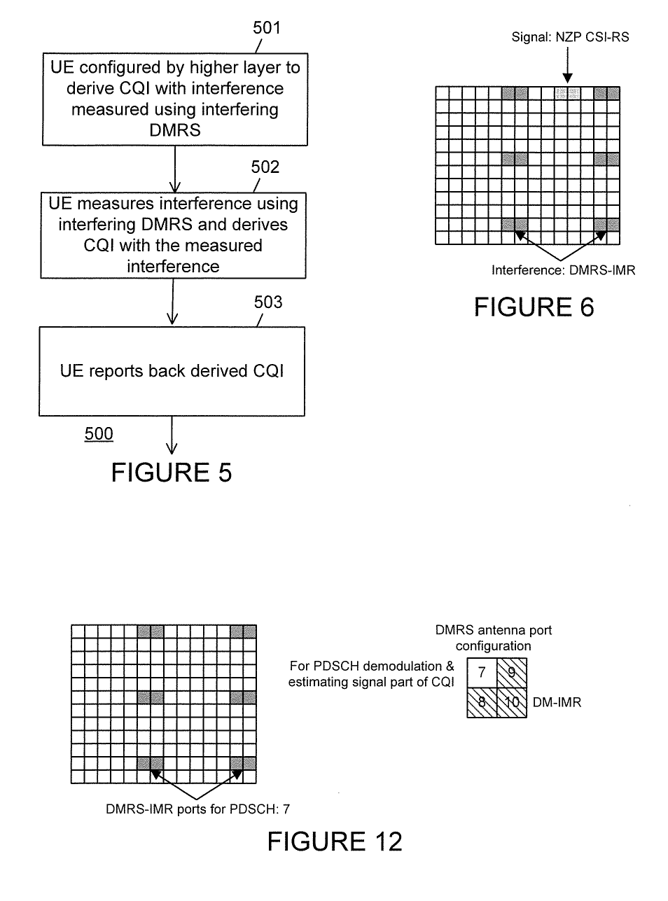

FIG. 5 is a high level flow diagram for a process 500 involved in the proposed DM-IMR based DMRS CQI computation and reporting in accordance with some embodiments of the present disclosure. A UE is configured with DM-IMR to measure interference for CQI computation using one of the various methods explained in this disclosure (step 501). Upon receiving the configuration, the UE measures the interference using the configured DM-IMR and computes CQI (step 502), where the signal part of the CQI may be estimated using either CSI-RS or DMRS, or both. Finally, the UE reports back (feeds back) the computed CQI to the TP using one the various reporting mechanisms mentioned later in this disclosure (step 503). The exemplary process 700 depicted is performed partially (steps on the right side) in the processor 110 of the visual search server 102 and partially (steps on the left side) in the processor 121 of the client mobile handset 105. While the exemplary process flow depicted in FIG. 5 and described herein involves a sequence of steps, signals and/or events, occurring either in series or in tandem, unless explicitly stated or otherwise self-evident (e.g., a signal cannot be received before being transmitted), no inference should be drawn regarding specific order of performance of steps or occurrence of the signals or events, performance of steps or portions thereof or occurrence of signals or events serially rather than concurrently or in an overlapping manner, or performance of the steps or occurrence of the signals or events depicted exclusively without the occurrence of intervening or intermediate steps, signals or events. Moreover, those skilled in the art will recognize that complete processes and signal or event sequences are not illustrated in FIG. 5 or described herein. Instead, for simplicity and clarity, only so much of the respective processes and signal or event sequences as is unique to the present disclosure or necessary for an understanding of the present disclosure is depicted and described.

In some embodiments of the present disclosure, a UE is configured to report either conventional CQI or DMRS-CQI, based upon a state of a one-bit codepoint in a UL related DCI format (DCI format 0 or 4), wherein the conventional CQI is derived with either CRS or NZP CSI-RS, sometimes together with CSI-IM, and the DMRS-CQI is derived such that the signal part is derived with either NZP CSI-RS or scheduled DMRS and the interference part is derived with DM-IMR.

A few methods to include the codepoint to indicate the CQI type in the UL related DCI format are described in this disclosure.

In one method, the codepoint is a new bit added to an existing UL related DCI format. In one example, a UE has received DCI format 0/4 in subframe n, wherein the CSI request field indicates that the UE should report CSI on a granted PUSCH in subframe n+k, wherein k is 4 if the serving cell operates in FDD frequency (frame structure type 1); or k is determined based upon the TDD UL/DL configuration if the serving cell operates in TDD frequency (frame structure type 2). If the state of the DCI format is further such that the state of codepoint is 1, then the UE shall report DMRS-CQI; if the state of codepoint is 0, then the UE shall report conventional CQI.

In another method, the codepoint is coupled with CSI request field.

In some embodiments, a UE is configured to report DMRS CQI together with hybrid automatic repeat request-acknowledge (HARQ-ACK) feedback on PUCCH, wherein the DMRS CQI is estimated in a subframe in which the UE has received a PDSCH, and the HARQ-ACK is with regards to the PDSCH. It is proposed to use PUCCH format 3 for carrying the DMRS CQI and the HARQ-ACK, because PUCCH format 3 can carry up to 22 bits. It is noted that the payload of the DMRS CQI can be 4 bits (1 codeword) or 7 bits (2 codewords).

In one embodiment, a UE is configured by higher-layer to derive CQI with the interference measured with DM-IMR. The UE further receives DCI format 2C or 2D which includes antenna port(s), scrambling identity and number of layers indication according to TABLE 1, wherein the indication configures a set of antenna ports and n_{SCID}. The UE is then further configured to use the DMRS generated with n_{SCID} on the set of antenna ports for deriving the signal part of the CQI, and to use DM-IMR determined according to MU-MIMO dimensioning configuration for deriving the interference part of the CQI.

In one example, the UE receives DCI format 2C or 2D, wherein the indication value is 1 and codeword 0 is enabled while codeword 1 is disabled. Then the UE refers to TABLE 1 and is configured to use the DMRS carried on (antenna ports, n_{SCID})=(7, 1) for demodulation. Then, the UE is further configured to use the DMRS on (7, 1) for deriving the signal part of the CQI, and to use DM-IMR determined according to MU-MIMO dimensioning configuration for deriving the interference part of the CQI.

In one method, the UE is configured with TM 8, 9, and 10, and the UE determines that MU-MIMO dimensioning is such that up to 4-UE MU-MIMO is supported, each with single transmission layer, wherein the corresponding 4 DMRS shall be respectively carried on (antenna port, n_{SCID})=(7, 0), (7, 1), (8, 0), (8, 1). In this case the UE derives interference utilizing the remaining 3 DMRS out of the MU-MIMO dimensioning other than (7, 1); the remaining 3 DMRS can be determined by (antenna port, n_{SCID})=(7, 0), (8, 0), and (8, 1). In this example, the serving eNB for the UE may schedule interfering streams intended to other UEs on resources associated with (antenna port, n_{SCID})=(7, 0), (8, 0), (8, 1).

A few other methods are devised and illustrated on how the UE determines DM-IMR for deriving interference part of the CQI in the following.

In one method, the UE is further semi-statically configured (by higher-layers, e.g., RRC) with an information for MU-MIMO dimensioning, which describes up to how many layers can be co-scheduled utilizing which multiplexing method.

In one example, the UE is further configured with the MU-MIMO dimension of {(7, 1), (8, 1)}, in which case the UE derives interference utilizing (antenna port, n_{SCID})=(8, 1).

In another method, the UE is further semi-statically configured (by higher-layers, e.g., RRC) with a set of DM-IMR. In one example, when the UE is configured with the DM-IMR set of {(8, 0), (8, 1)}, then the UE derives interference using the configured set.

In one embodiment, a UE is configured with a port mapping table such as TABLE 4 below, which is specially designed to support simultaneous transmission of up to 8 streams, wherein each UE can be scheduled with only up to 2 layers and all the 8 layers are supported with orthogonal DMRS of antenna ports 7-14. For example, eNB can use MU-MIMO to simultaneously serve 8 different UEs each with single stream, wherein the 8 UEs are respectively assigned with antenna ports 7 through 14.

When the UE receives a DCI containing this indication, the UE check the value of the indication bits and the enabled/disabled states of the two codewords to determine how many layers on which the UE shall receive PDSCH and what antenna ports to use for DMRS for demodulating the PDSCH.

In TABLE 4, the 2-layer states are constructed such that each state indicates DMRS on the same CDM set. For example, the value 2 in case two codewords are enabled is associated with antenna ports 11 and 13, whose DMRS are mapped on the same set of resource elements and multiplexed with different CDM Walsh covers.

TABLE 4
Antenna port(s), and number of layers indication

| One Codeword: | | Two Codewords: | |
|---|---|---|---|
| Codeword 0 enabled, | | Codeword 0 enabled, | |
| Codeword 1 disabled | | Codeword 1 enabled | |
| Value (2 bits + | | Value | |
| disabled NDI bit) | Message | (2 bits) | Message |
| 0 | 1 layer, port 7 | 0 | 2 layers, ports 7, 8 |
| 1 | 1 layer, port 8 | 1 | 2 layers, port 9, 10 |
| 2 | 1 layer, port 9 | 2 | 2 layers, ports 11, 13 |
| 3 | 1 layer, port 10 | 3 | 2 layers, ports 12, 14 |
| 4 | 1 layer, port 11 | | |
| 5 | 1 layer, port 12 | | |
| 6 | 1 layer, port 13 | | |
| 7 | 1 layer, port 14 | | |

In one embodiment, a UE is configured by higher-layer to derive CQI with the interference measured with DM-IMR, and is further configured to use TABLE 4 for determining DMRS port(s) for PDSCH scheduled by a DCI, wherein the DCI format configures a set of antenna ports. The UE is then further configured to use the DMRS generated with a pre-configured n_{SCID} on the set of antenna ports for deriving the signal part of the CQI, and to use DM-IMR determined according to MU-MIMO dimensioning configuration for deriving the interference part of the CQI.

In one example, the UE further decodes the DCI containing antenna port(s), and number of layers indication as defined in TABLE 4, wherein the state of the indication bits indicate to estimate channels for demodulating its signal utilizing antenna ports 7, 8 (i.e., corresponding to value 0 of 2-codeword case in TABLE 4). Then the UE utilizes DMRS on antenna ports 7 and 8 for deriving the signal part of the CQI. As two antenna ports are scheduled for PDSCH, the UE derives 2 CQI for 2 code-words in this case.

Regarding how the UE determines DM-IMR for deriving interference part of the CQI, a few methods are devised and illustrated in the following.

In one method, the UE is configured to estimate interference utilizing the rest of the antenna ports that can be configured by TABLE 4, which are antenna ports 9, 10, 11, 12, 13, and 14.

In another method, the UE is semi-statically configured (by higher-layers, e.g., RRC) with a set of antenna ports for the MU-MIMO dimensioning. For example, the UE is configured with MU-MIMO dimensioning {7,8,11,13}. In this case the DMRS to derive interference is the rest of the antenna ports from the MU-MIMO dimensioning antenna ports of {7,8,11,13} which are antenna ports 11 and 13.

In another method, the UE is further semi-statically configured with a set of DM-IMR ports. For example, when the UE is configured with the DM-IMR set of {11,13} then the UE derives interference using the configured set of antenna ports.

In one embodiment, a UE is configured by higher-layer to estimate the signal part of the CQI with non-zero-power (NZP) CSI-RS, and the interference part of the CQI with DM-IMR. FIG. 6 illustrates an exemplary RE mapping of a PRB used for estimating signal and interference part of the CQI, wherein the UE utilize the configured NZP CSI-RS to estimate CSI-RS and DM-IMR to estimate interference for the CQI, in accordance with some embodiments of the present disclosure. The RE mapping in a PRB used for estimating signal and interference part of the CQI includes RE pairs used for interference (DMRS-IMR) in the first, sixth and eleventh rows at the columns corresponding to l=5, 6 of both the even-numbered slots and the odd-numbered slot and an RE pair used for signal (NZP CSI-RS) in the first row at columns corresponding to l=2, 3 of the odd-numbered slot.

For this operation, the UE can be configured with a newly-defined CSI process (denoted as a CSI process of new type), comprising an NZP CSI-RS and DM-IMR.

In this case, the UE can derive PMI, RI as well as CQI utilizing the resources configured with the CSI process of new type, as NZP CSI-RS comprises reference signals for multiple logical antenna ports, on which (PMI) precoding can be applied. It is furthermore noted that it may not be feasible to derive PMI/RI out of DMRS transmitted together with the scheduled PDSCH because DMRS is already precoded.

The signal and interference parts of the CQI are estimated in the same subframe based on the CSI process of the new type. Furthermore, the signal and interference parts are estimated in the same set of the physical resource blocks (PRBs). In one example, when the PRBs containing DM-IMR is configured, wideband CQI is estimated by relying on NZP CSI-RS and DM-IMR on the PRBs containing DM-IMR.

Further, the signal and interference parts of the CQI can be estimated in a set of subframes. In one example the set of subframes is two consecutive subframes.

In one embodiment, the UE is configured by higher-layer to estimate the interference part of the CQI with DM-IMR. The UE is further configured to process a UL grant DCI format (e.g., DCI format 0 or 4) including a codepoint indicating how to derive and report CQI according to the configured CSI process of new type. If the codepoint instructs the UE to report the CQI estimated with the aid of DM-IMR, the UE estimates the interference part of the CQI relying on the DM-IMR in the subframe in which the UE has received the UL grant DCI format reports the estimated CQI on the scheduled PUSCH.

In one example, the codepoint comprises two-bit information, and the codepoint is generated by the CSI request bits. In this case, the UE is further semi-statically configured (by higher-layer signaling, or RRC) with a set of candidate DM-IMR, and which set to use for deriving the interference for CQI estimation is dynamically indicated by the two-bit information, e.g., according to TABLE 5:

TABLE 5
CSI request field for interference measurement

| Value of CSI | |
|---|---|
| request field | Description |
| ‘00’ | No aperiodic CSI report is triggered |
| ‘01’ | Aperiodic CSI report is triggered, |
| | wherein the CSI is derived with interference |
| | estimated with a 1st set of DM-IMR |
| ‘10’ | Aperiodic CSI report is triggered, |
| | wherein the CSI is derived with interference |
| | estimated with a 2nd set of DM-IMR |
| ‘11’ | Aperiodic CSI report is triggered, |
| | wherein the CSI is derived with interference |
| | estimated with a 3rd set of DM-IMR |

If the UE has also decoded a DL assignment DCI intended to the UE in the same subframe where the UE has received the UL grant DCI, the DM-IMR is determined according to the downlink assignment resource allocation in the subframe. In this case, the PMI/CQI can be seen as “wideband” or “subband” depending on the locations of the assigned resource blocks. For example, if the resource allocation is distributed, the PMI/CQI reported can be considered “wideband.” If the resource allocation is localized, the PMI/CQI reported can be considered “subband.”

In one embodiment, UE is configured to use a set of DMRS ports to estimate the signal part of the CQI in a set of subframes and use the same set of DMRS ports to estimate the interference part in another set of subframes. Based on that, UE estimates CQI utilizing the signal and interference parts estimated in the two sets of subframes.

In one example, a UE is indicated with the value 1 and codeword 0 enabled while codeword 1 disabled in DCI format 2C or 2D. Then, the UE derives the signal part of the CQI utilizing the DMRS carried on (antenna ports, n_{SCID})=(7, 1) in a first set of subframes, and derives the interference part of the CQI utilizing the DM-IMR carried on (antenna ports, n_{SCID})=(7, 1) in a second set of subframes.

In one embodiment, the CSI (including one or more of PTI/RI/PMI/CQI) estimated with the aid of DM-IMR can be reported either on PUCCH in a periodic manner or on PUSCH in aperiodic manner.

A UE can be configured with a PUCCH reporting configuration (e.g. in the form of periodicity and subframe offset), which indicates the subframes to be used by the UE for reporting CSI.

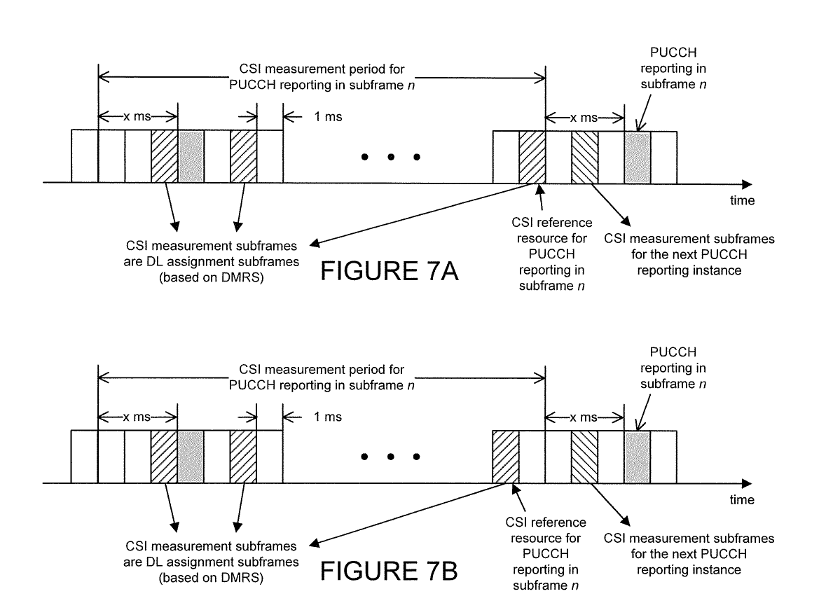

In one method, the CSI is derived by averaging measurements in measurement subframes between two PUCCH reporting instances, e.g. between two instances of RI reports, or between two instances of CQI reports (if RI/PMI reports are not required/configured). This method is illustrated in FIGS. 7A and 7B. The exemplary PUCCH reporting (with x=3 in the example shown) is shown with different locations for the CSI reference resource: in the last time period within the CSI measurement period for PUCCH reporting in subframe n in FIG. 7A, versus in the next to last time period within the CSI measurement period for PUCCH reporting in subframe n in FIG. 7B.

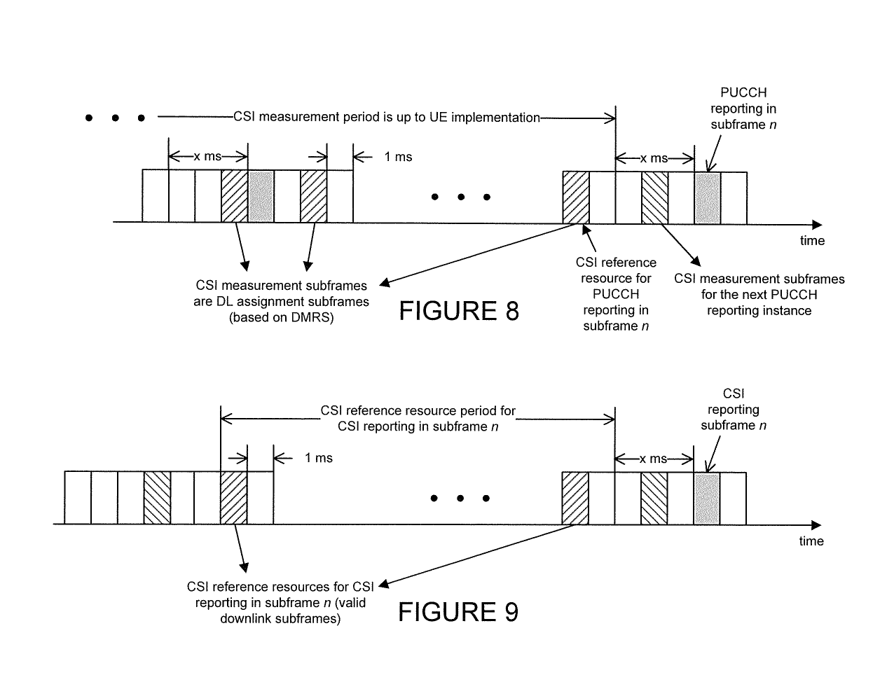

In another method, the CSI is derived by averaging measurements in measurement subframes before a PUCCH/PUSCH reporting instance (i.e., there is no restriction on a subframe from which a UE can perform the measurement), e.g. before an instance of RI report, or before an instance of CQI report (if RI/PMI reports are not required/configured). The actual CSI measurement period can be up to UE implementation as shown in FIG. 8. The exemplary PUCCH reporting (with x=3 in the example shown) is shown with the CSI reference resource in the next to last time period within the UE implementation-specific CSI measurement period in FIG. 8.

Since UE requires some CSI processing time before it is able to send a CSI report in subframe n, the measurement subframes within x ms period (e.g. x=3, 4 or 5) before the reporting subframe n can be excluded from the report in subframe n. The excluded measurement subframes can be included in the next PUCCH reporting instance after subframe n.

A CSI measurement period can be defined to be a period from a PUCCH reporting subframe minus x subframes to the next PUCCH reporting subframe minus x subframes, as illustrated in FIGS. 7A and 7B.

The reference CSI resource [Sec 7.2.3 of 3GPP TS 36.213] can be the most recent measurement subframe before subframe n−x (as shown in FIGS. 7A and 7B and FIG. 8).

In one example, the measurement subframes are determined to be the subframes in which PDSCH is scheduled (or in which DL assignment DCI format is transmitted) for the UE. When this method is applied, it is possible that there are no measurement subframes in between two PUCCH reports. When this happens, in one alternative, the UE drops (does not transmit) the PUCCH report for power saving and interference reduction; in another alternative, the UE reports OOR (Out Of Range) for the CQI; in yet another alternative, UE retransmits the last PUCCH report.

In one embodiment, a UE is configured by higher-layer to estimate the interference part of the CQI with DM-IMR. Further, the UE is configured with CSI reference resource period, wherein the CSI reference resource period is a set of downlink subframes for a serving cell in the time domain, and the UE is allowed to estimate at least the interference part of the CQI by averaging the interference on the DM-IMR within the period. The UE may also be allowed to estimate the signal part of the CQI by averaging the signal on either scheduled DMRS, or NZP CSI-RS within the period.

This is beneficial if the CQI reported by the UE has to satisfy a performance requirement for an average channel condition corresponding to the downlink subframes belonging to the CSI reference resource. In one use case, eNB can utilize the CQI reported by the UE for multi-user MIMO scheduling, especially when the MU interference changes over a scheduling period. According to the described use case, the UE may assume multiple downlink subframes as the CSI reference resource period if it is configured to operate in MU-MIMO mode or to report MU-CQI.

The CSI reference resource period can be defined such that all valid downlink subframes within the CSI reference resource period are part of the CSI reference resource. In particular, the CSI reference resource period can be defined to include downlink subframes from downlink subframe n−nCQI_{—ref}−nCQI_{—ref}_{_{—}}_{period} to downlink subframe n−nCQI_{—ref}, wherein subframe n is the subframe in which CSI is reported, nCQI_{—ref} is as defined in Section 7.2.3 of 3GPP TS 36.213 and nCQI_{—ref}_{_{—}}_{period} is the CSI reference resource period. The concept of a CSI reference resource period is illustrated in FIG. 9. The CSI reference resource period can be redefined or configurable by the eNodeB, e.g., by higher layer signaling such as the RRC. Enabling configurability for CSI reference resource period is beneficial for the eNodeB to adapt the CSI reference resource period according to its MU scheduling strategy.

The CSI reference resource period can also be defined as the M valid downlink subframes before and including the downlink subframe n−nCQI_{—f}. Similarly, M can be predefined or configured by the eNodeB, e.g. by higher layer signaling such as the RRC.

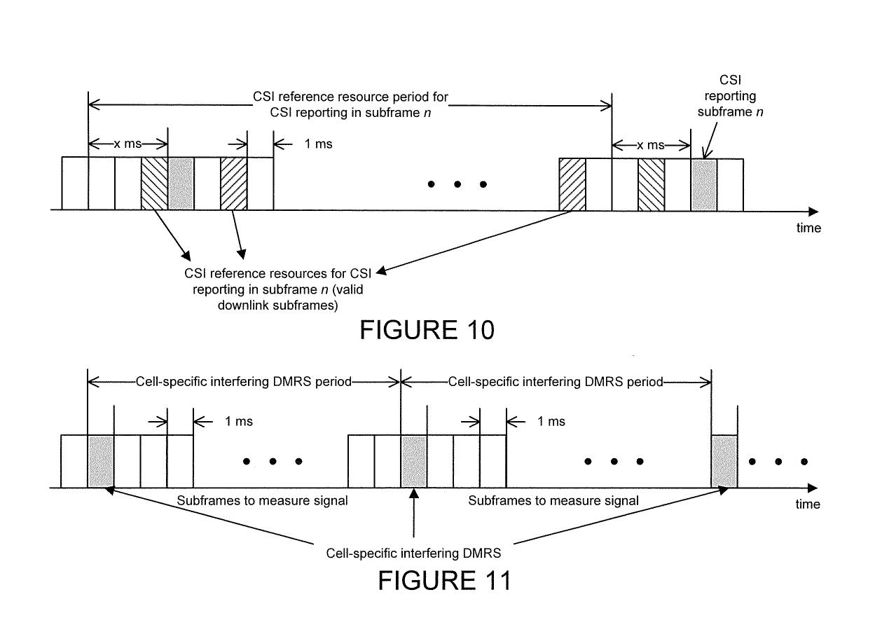

The CSI reference resource can also be defined to be all valid downlink subframes that have not been taken into account by the UE since the last CSI report. This can be useful e.g. for PUCCH CSI reporting (periodic CSI reporting) where the CQI report provides, e.g., the MU-CQI that is valid for the period since the last reported CSI. This is illustrated in FIG. 10.

The above-described embodiments require UE-specific signaling to indicate DMRS ports for interference measurement, which leads to increased signaling overhead. In order to reduce the overhead, a cell-specific signaling of DMRS ports for interference measurement may be considered.

In one example, DM-IMR ports may be pre-determined, hence no further signaling is needed.

In one method, a subframe may be dedicated for interference measurement using cell-specific DM-IMR ports. This cell-specific DM-IMR port configuration may be aperiodic or periodic. Furthermore, it may be semi-statically signaled through higher-layer signaling such as RRC. FIG. 11 illustrates an example of a periodic cell-specific DM-IMR.

In one embodiment, a UE is configured by higher-layer to estimate the signal part of the CQI with DMRS for demodulating PDSCH, and the interference part of the CQI with DM-IMR. FIG. 12 illustrates a PRB used for estimating signal and interference parts of the CQI when the UE has received PDCCH whose codepoints indicate to use DMRS port 7 as demodulation reference. Then the UE utilizes DMRS port 7 to estimate the signal part and DMRS ports 8, 9, and 10 as DM-IMR to estimate the interference part of the CQI. In the example of FIG. 12, a single PRB is used for signal estimation, using DMRS for PDSCH modulation and interference estimation using DM-IMR.

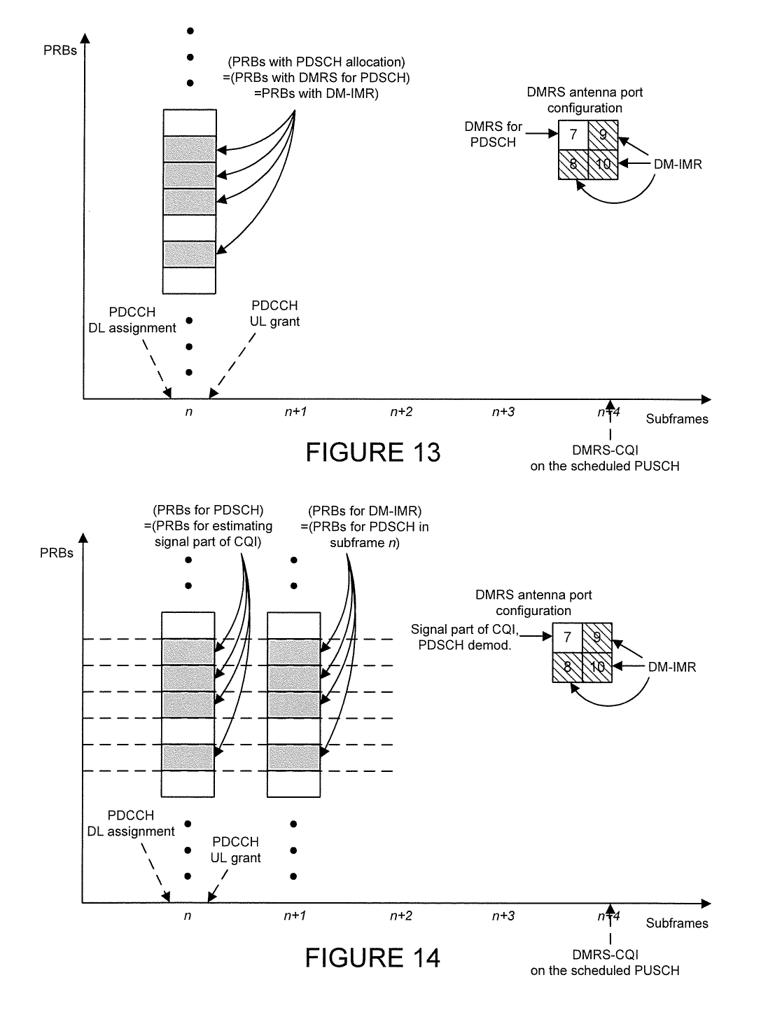

FIG. 13 illustrates that the signal and the interference parts of the CQI are estimated in the same subframe n based on the configuration. In particular, the signal and the interference parts are estimated in the same set of PRBs in subframe n, wherein DMRS port 7 is configured for both PDSCH demodulation and estimating the signal, and DMRS ports 8, 9, and 10 are configured for DM-IMR in each PRB. Based on the configuration, the UE estimates the signal and interference parts of the CQI and reports the derived CQI, for example in subframe n+4 on the scheduled PUSCH.

In one method, as shown in FIG. 14, the signal and interference parts of the CQI are estimated in two different subframes, for example n and n+1, respectively. In particular, the DMRS port 7 is configured for both PDSCH demodulation and estimating the signal using the set of PRBs in subframe n, and DMRS ports 8, 9, and 10 are configured for DM-IMR using the same set of PRBs in subframe n+1. Based on the configuration, the UE estimates the signal and interference parts of the CQI and reports the derived CQI, for example in subframe n+4 on PUSCH.

In one embodiment, the signal and interference parts of the CQI are estimated using the same set of DMRS ports in two different subframes, for example n and n+1, respectively.

In one example, a UE is indicated with the value 1 and codeword 0 enabled while codeword 1 disabled in DCI format 2C or 2D. Then, the UE derives the signal part of the CQI utilizing the DMRS carried on (antenna ports, n_{SCID})=(7, 1) in subframe n, and derives the interference part of the CQI utilizing the DM-IMR carried on (antenna ports, n_{SCID})=(7, 1) in subframe n+1.

In one method, such a configuration is pre-determined or is semi-statically configured by higher-layer such as RRC.

In another method, the configuration to use the same set of DMRS ports for demodulating PDSCH in subframe n and for DM-IMR in subframe n+1 is indicated together in subframe n, for example, using a DCI carried on PUCCH in subframe n.

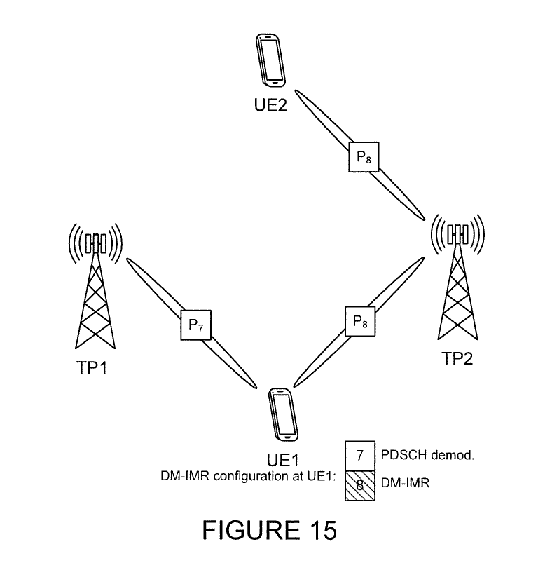

In one embodiment related to the coordinated multipoint transmission (CoMP), the desired signal is transmitted from one transmission point (TP1) and the interfering signal is transmitted from another transmission point TP2. In one example, as shown in FIG. 15, UE1 is configured with DM-IMR on DMRS port 8 to estimate interference coming from TP2 while it is configured to use DMRS port 7 for demodulating PDSCH from TP1.

In one example, a UE is configured with DM-IMR by higher-layer to estimate the interference for MU-CQI computation under CoMP MU-MIMO.

In one example, a UE is configured to receive NZP CSI-RS from TP1 to estimate the signal part of the MU-CQI, and is configured to receive DMRS from TP2 to estimate interference part of MU-CQI under CoMP transmission.

In one example, a UE is configured to receive DMRS from TP1 to estimate the signal part of the MU-CQI, and is configured to receive DMRS from TP2 to estimate interference part of MU-CQI under CoMP transmission.

Alternative Ways of MU-CQI Derivation and Configuration

Consider an eNB's MU-MIMO transmission to two UEs, UE1 and UE2, whose precoding vectors are denoted by w₁ and w₂. Then, the received signal y₁ at UE1 can be represented as:

y₁=h₁(w₁x₁+w₂x₂)+z₁,

where h₁ is the channel vector for UE1, x₁ and x₂ are the modulation symbols for UE1 and UE2 respectively, and z₁ is the background noise at UE1. If UE1 has a minimum mean square error interference rejection combining (MMSE-IRC) receiver, the receiver signal-to-interference-plus-noise ratio (SINR) at the UE is calculated as F_{MMSE}y₁, where

F_{MMSE}=(h₁w₁)^{H}R_{MMSE}⁻¹=(h₁w₁)^{H}((h₁w₁)(h₁w₁)^{H}+(h₁w₂)(h₁w₂)^{H}+Σ_{Z})⁻¹,

where Σ_{Z} is covariance of z₁. Examining the expression for F_{MMSE}y₁, it can be seen that for estimating the SINR after the MMSE-IRC receiver, UE1 needs to know the following two terms:
(h₁w₁): precoded channel for UE1;
((h₁w₁)(h₁w₁)^{H}+(h₁w₂)(h₁w₂)^{H}+Σ_{Z}): covariance matrix of signal+interference (=MU interference+background noise).

When DMRS is configured for PDSCH demodulation, UE1 can estimate the first term using the configured DMRS estimates, and the second term out of the covariance matrix of received PDSCH.

In some embodiments, a UE is configured to feedback MU-CQI, wherein the UE is further configured to derive its signal part using CSI-RS, and its (signal+interference) part using the configured CSI-IM for calculation of the MU-CQI. In this case, using the CSI-IM, the UE can calculate the second term for MMSE-IRC filtering, i.e, ((h₁w₁)(h₁w₁)^{H}+(h₁w₂) (h₁w₂)^{H}+Σ_{Z}).

In some embodiments, a UE is configured to derive and feedback MU-CQI utilizing DMRS, wherein the UE is further configured to derive its signal part using the configured DMRS for PDSCH demodulation, and its (signal+interference) part using the received PDSCH for calculation of the MU-CQI. The measurement subframes and PRBs for MU-CQI derivation can be determined according to same methods as those used for determining those for DM-IMR in other embodiments in this disclosure. Also, the MU-CQI reporting can be done in the same methods as those used for determining those for DM-IMR in other embodiments in this disclosure.

MU-CQI can provide performance gain and better user experience. Traditionally SU-CQI has been used for MU rank-adaptation, in which case the MCS level used for MU are apt to be too optimistic, resulting in bursts of errors, hurting performance and user experience until the outer-loops converge.

MU-CQI can also have benefits for FD MU-MIMO. One of the main benefits FD-MIMO provides is capacity increase, based upon MU-MIMO. Usage of prior specifications for MU-MIMO was quite limited because the gain was small and the operation reliability was lacking. On the other hand, one major driving force of FD-MIMO to outperform traditional MIMO is FD-MIMO, in which case MU-MIMO is very important. In order to make FD MU-MIMO reliably work with promised capacity gain in practice, it is important to introduce MU-CQI in the standards.

MU-CQI has been discussed multiple times, with mainly two categories so far: (1) best/worst companion MU-CQI, in which UEs derive MU-CQI with interfering precoder hypothesis, and (2) MU interference emulation on CSI-IM. The well-known drawback of the former approach is that the interfering hypothesis for UE to derive CQI may not be aligned with actual BS scheduling, in which case the MU-CQI is useless. The latter approach incurs large overhead and could only provide interference power, rather than an interference channel matrix, and is thus an inferior MU-CQI estimation method to the proposed DMRS-MU-CQI. This disclosure provides comprehensive and detailed coverage on DMRS-MU-CQI.

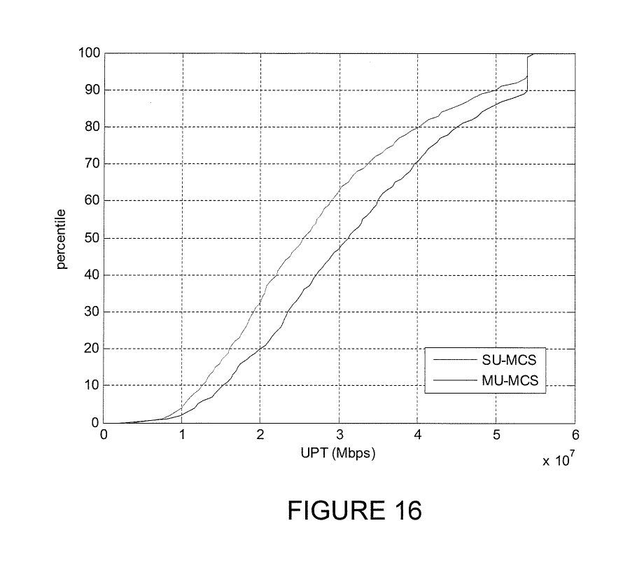

FIG. 16 is a plot illustrating comparative performance of SU-CQI (upper trace) and the proposed MU-CQI (lower trace). The proposed MU-CQI achieves 23% higher user perceived throughput (UPT) than SU-CQI. Resource utilization (RU) is also reduced to 33% from 37%. “MU-CQI” calculated according to the above-described previously discussed methods is not useful if the eNB does not use the same PMI as the feedback PMI, which applies to both the best/worst companion CQI and IMR based CQI.

For an MMSE-IRC receiver for UE1 whose precoded channel is h₁, F_{MMSE}=h₁^{H}R_{MMSE}⁻¹=h₁^{H}(h₁h₁^{H}+h₂h₂^{H}+Σ_{I})⁻¹. When an MMSE-IRC receiver is used, MU-CQI can be estimated if R_{MMSE}⁻¹ and h₁^{H} can be estimated at the UE. In the present disclosure, h₁^{H} is estimated using CSI-RS and a selected precoder, while R_{MMSE} can be estimated if the eNB induces (or transmits) a MU aggregated signal (or MU precoded signal of a form of w₁x₁+w₂x₂) on either IMR or CSI-RS. Accordingly, when a UE is configured to estimate MU-CQI (e.g., by one bit higher-layer indication), the UE estimates R_{MMSE}⁻¹ using the signal estimated in the IMR (or CSI-RS). This differs from alternatives in which IMR are provided for facilitating interference estimation (i.e., either for h₂h₂^{H}+Σ_{I} or Σ_{I}).

For an MMSE-IRC receiver for UE1 whose precoded channel is h₁, F_{MMSE}=h₁^{H}R_{MMSE}⁻¹=h₁^{H}(h₁h₁^{H}+h₂h₂^{H}+Σ_{I})⁻¹. When an MMSE-IRC receiver is used, MU-CQI can be estimated if R_{MMSE}⁻¹ and h₁^{H} can be estimated at the UE. In the present disclosure, h₁^{H} can be estimated using configured DMRS for PDSCH, while R_{MMSE}⁻¹ can be estimated using received PDSCH modulation symbols. Accordingly, when a UE is configured to estimate MU-CQI (e.g., by one bit higher-layer indication), the UE estimates R_{MMSE}⁻¹ using the signal estimated in the IMR (or CSI-RS). This again differs from alternatives in which IMR are provided for facilitating interference estimation (i.e., either for h₂h₂^{H}+Σⱼ or Σ₁).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user equipment, comprising:
a receiver configured to receive, via a first set of demodulation reference signal (DMRS) antenna ports, a set of physical resource blocks (PRBs) in a single subframe on a physical downlink shared channel (PDSCH) from a transmission point in a wireless communication system, each of the PRBs including a demodulation interference measurement resource (DM-IMR) received via at least one DMRS antenna port other than the first set of DMRS antenna ports;
a controller configured to demodulate the PDSCH, to estimate a signal part of channel quality information (CQI) from a PRB in the set of PRBs received via the first set of DMRS ports, and to determine an interference part of the CQI based upon DM-IMRs within PRBs in the set of PRBs received via the at least one other DMRS antenna port; and
a transmitter configured to transmit, to the transmission point, an indication of the CQI.

2. The user equipment according to claim 1, wherein the first set of DMRS antenna ports comprises a subset of a predetermined group of DMRS antenna ports and the at least one other DMRS antenna port comprises all DMRS antenna ports within the predetermined group other than the first set of DMRS antenna ports.

3. The user equipment according to claim 1, wherein the DM-IMR is DMRS other than those scrambled according to a specified scrambling initialization parameter.

4. The user equipment according to claim 1, wherein the DM-IMR is configured by a higher layer.

5. The user equipment according to claim 1, wherein information regarding physical resource blocks (PRBs) containing the DM-IMR is signaled to the user equipment.

6. The user equipment according to claim 1, wherein information regarding a set of subframes containing the DM-IMR is signaled to the user equipment.

7. The user equipment according to claim 1, wherein the DM-IMR is determined according to a downlink assignment resource allocation in a downlink subframe.

8. The user equipment according to claim 1, wherein the user equipment is selectively configured to report one of CQI without interference measurement and DMRS-CQI.

9. The user equipment according to claim 1, wherein the user equipment is configured to report DMRS-CQI together with a hybrid automatic repeat request-acknowledge (HARQ-ACK) feedback on a physical uplink control channel (PUCCH), and wherein the DMRS-CQI is estimated in a subframe in which the user equipment received the set of PRBs.

10. The user equipment according to claim 1, wherein the user equipment is configured with a port mapping table designed to support simultaneous transmission of up to eight streams.

11. A base station, comprising:
a transmitter configured to transmit, for reception at a user equipment via a first set of demodulation reference signal (DMRS) antenna ports, a set of physical resource blocks (PRBs) in a single subframe on a physical downlink shared channel (PDSCH) in a wireless communication system, each of the PRBs including a demodulation interference measurement resource (DM-IMR) for reception at the user equipment via at least one DMRS antenna port other than the first set of DMRS antenna ports;
a receiver configured to receive, from the user equipment, an indication of channel quality information (CQI) determined by the user equipment by estimating a signal part of the CQI from a PRB in the set of PRBs received at the user equipment via the first set of DMRS ports and by determining an interference part of the CQI based upon DM-IMRs within PRBs in the set of PRBs received at the user equipment via the at least one other DMRS antenna port.

12. The base station according to claim 11, wherein the first set of DMRS antenna ports comprises a subset of a predetermined group of DMRS antenna ports and the at least one other DMRS antenna port comprises all DMRS antenna ports within the predetermined group other than the first set of DMRS ports.

13. The base station according to claim 11, wherein the DM-IMR is DMRS other than those scrambled according to a specified scrambling initialization parameter.

14. The base station according to claim 11, wherein the DM-IMR is configured by a higher layer.

15. The base station according to claim 11, wherein information regarding physical resource blocks (PRBs) containing the DM-IMR is signaled to the user equipment.

16. The base station according to claim 11, wherein information regarding a set of subframes containing the DM-IMR is signaled to the user equipment.

17. The base station according to claim 11, wherein the DM-IMR is determined according to a downlink assignment resource allocation in a downlink subframe.

18. The base station according to claim 11, wherein the base station is configured to receive one of CQI without interference measurement and DMRS-CQI.

19. The base station according to claim 11, wherein the base station is configured to receive the DRMS-CQI together with a hybrid automatic repeat request-acknowledge (HARQ-ACK) feedback on a physical uplink control channel (PUCCH), and wherein the DRMS-CQI is estimated in a subframe in which the user equipment received the PRBs.

20. The base station according to claim 11, wherein the base station is configured to employ a port mapping table designed to support simultaneous transmission of up to eight streams.
